(19) United States
(12) Patent Application Publication
(10) Pub. No.: US 2013/0110363 A1
(43) Pub. Date: May 2, 2013

(54) HYSTAT DRIVE SYSTEM HAVING ENGINE SPEED CONTROL

(71) Applicants: Michael W. RIES, Coon Rapids, MN (US); Paul A. DVORAK, Sanford, NC (US); Mark L. NORTON, Eden Prairie, MN (US); Jon M. SCHARF, Maple Grove, MN (US)

(72) Inventors: Michael W. RIES, Coon Rapids, MN (US); Paul A. DVORAK, Sanford, NC (US); Mark L. NORTON, Eden Prairie, MN (US); Jon M. SCHARF, Maple Grove, MN (US)

(21) Appl. No.: 13/470,934

(22) Filed: May 14, 2012

Related U.S. Application Data
(60) Provisional application No. 61/554,130, filed on Nov. 1, 2011.

(51) Int. Cl. B60W 10/06; B60W 10/30; B60W 10/10

(52) U.S. Cl. 701/54

(57) ABSTRACT

A drive system for a mobile machine is disclosed. The drive system may have an engine-driven pump, and a motor connected to the pump. The drive system may also have a speed input to select a maximum allowable engine speed, a throttle input to indicate a desired speed of the engine as a function of the maximum allowable engine speed, a transmission input to select a desired transmission control setting, and a controller configured to selectively adjust operation of the engine based on the throttle input and to selectively limit the actual engine speed based on the maximum allowable speed. The controller may also select for use a particular relationship between the actual engine speed and a travel speed from a plurality of available relationships based on the desired transmission control setting, and selectively adjust displacements of the pump and motor based on the actual engine speed and the selected particular relationship.

### RELATED APPLICATIONS

This application is based on and claims the benefit of priority from U.S. Provisional Application No. 61/554,130 by Michael W. RIES et al., filed Nov. 1, 2011, the contents of which are expressly incorporated herein by reference.

### TECHNICAL FIELD

The present disclosure is directed to a machine drive system, and more particularly, to a hystat drive system having engine speed control.

### BACKGROUND

Machines such as wheeled compactors, loaders, trucks, and other mobile equipment are used to perform many tasks. To effectively perform these tasks, the machines require an engine that provides significant torque through a transmission to one or more ground engaging traction devices. Such machines usually include conventional manual or automatic transmissions having a discrete number of step-changed output ratios (gears) to control the speed and torque of the ground engaging devices. The output ratios correspond to travel speed ranges, each having a predefined maximum travel speed. For example, an operator can place a wheeled compactor in a second of available gears and, when the accelerator pedal is fully depressed, the compactor may accelerate to a maximum travel speed of about 13 kph.

Consequently, operators are accustomed to using certain gears for accomplishing specific tasks. For example, a compactor operator may know that the speed range of second gear is appropriate for effectively compacting an asphalt layer of a given thickness. Likewise, the operator may know that the speed range of third gear is appropriate for safely traveling across a worksite. Additionally, the speed range associated with each gear of a given machine type (e.g., wheeled compactor) is fairly standard across different machines and different manufacturers. Therefore, operators have become comfortable using specific speed ranges for specific tasks, despite using a variety of machines.

Recently, however, conventional manual and automatic transmissions are being replaced by hydrostatic transmissions (hystats). A hystat provides an infinitely variable torque-to-speed output ratio within its overall range through the pairing of a variable displacement pump and a fixed- or variable-displacement motor. Although a hystat is known to have higher efficiency and extended functionality when compared with a power-shift transmission, it does not behave in the manner discussed above with respect to the discrete speed ranges of earlier transmission types. Specifically, fully depressing the accelerator pedal in a machine with a hystat will cause the machine to accelerate to a maximum possible speed, as the hystat uses its full range of output ratios. Therefore, operators must hold the accelerator pedal in an intermediate position in order to travel at a desired speed less than the maximum. This proves very difficult in rough terrain common to many worksites and causes undue operator fatigue. Accordingly, there is a need to limit the travel speed of a machine with a hystat in an alternative manner.

One such method of machine control is described in U.S. Pat. No. 7,373,776 (the '776 patent) of Burgart et al. that issued on May 20, 2008. The '776 patent describes a hystat drive system having a variable-displacement pump paired with a fixed-displacement motor. The hystat drive system includes a shift lever that provides operator input regarding travel direction and selection of a particular transmission gear ratio, a throttle pedal that provides operator input regarding a desired engine speed, and a clutch that provides for temporary reduction in the transmission gear ratio. A micro-controller receives information from the shift lever, the throttle pedal, and the clutch, and responsively generates control signals that set the displacement of the pump to a fixed value and regulates engine speed, while ensuring that a resulting speed of the motor remains less than a known maximum speed limit.

Although the system of the '776 patent may provide for discrete control over hystat operation, it may be less than optimal. In particular, the '776 patent does not allow the operator to set the maximum speed limit of the motor, the micro-controller does not have displacement control over the motor, and the fixed ratio control over pump displacement may be insufficient in some applications. In addition, the micro-controller does not have overspeed or stall override capabilities or direction-switching control. Accordingly, the '776 patent may be lacking features that enhance machine performance and/or operator control.

The system of the present disclosure solves one or more of the problems set forth above and/or other problems of the prior art.

### SUMMARY OF THE INVENTION

One aspect of the present disclosure is directed to a drive system for a mobile machine. The drive system may include an engine, a pump driven by the engine to pressurize fluid, and a motor hydraulically connected to the pump via an inlet passage and an outlet passage. The drive system may also include a speed input movable by an operator to select a maximum allowable speed of the engine, a throttle input movable by the operator to indicate a desired speed of the engine as a function of the maximum allowable speed, and a transmission input movable by the operator to select a desired transmission control setting from a plurality of available transmission control settings. The drive system may further include a controller in communication with the engine, the pump, the motor, the throttle input, the speed input, and the transmission input. The controller may be configured to selectively adjust operation of the engine based on the throttle input to reduce a difference between an actual engine speed and the desired speed of the engine. The controller may also be configured to select for use a particular relationship between the actual engine speed and a travel speed of the mobile machine from a plurality of available relationships based on the desired transmission control setting selected by the operator, and to selectively adjust displacements of the pump and the motor based on the actual engine speed and the selected particular relationship.

Another aspect of the present disclosure is directed to a method of driving a mobile machine. The method may include pressurizing fluid with an engine-powered pump, and directing pressurized fluid from the pump through a motor to propel the mobile machine. The method may also include receiving a first operator input indicative of a maximum allowable engine speed, receiving a second operator input indicative of a desired engine speed as a function of the maximum allowable speed, and receiving an operator selection of a desired transmission control setting from a plurality of available transmission control settings. The method may further include selectively adjusting operation of an engine based on a difference between the desired engine speed and an actual engine speed. The method may additionally include selecting for use a particular relationship between the actual engine speed and a travel speed of the mobile machine from a plurality of available relationships based on the desired transmission control setting selected by an operator of the mobile machine, and selectively adjusting displacements of the pump and motor based on the actual engine speed and the selected particular relationship.

### BRIEF DESCRIPTION OF THE DRAWINGS

FIG. 1 is a diagrammatic illustration of an exemplary disclosed machine;

FIG. 2 is a diagrammatic illustration of an exemplary disclosed drive system and an exemplary disclosed operator station for use with the machine of FIG. 1; and

FIG. 3 is an exemplary disclosed method of operating the drive system of FIG. 2 in response to signals received from the operator station.

### DETAILED DESCRIPTION

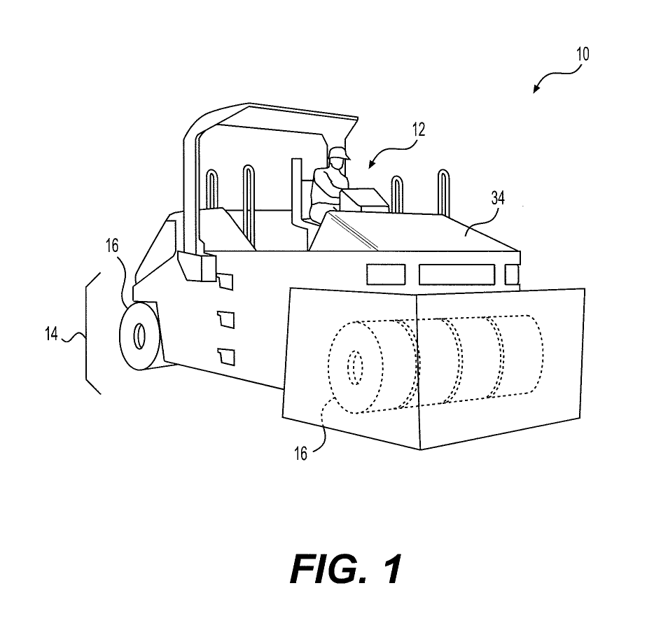

FIG. 1 illustrates an exemplary machine 10 having multiple systems and components that cooperate to accomplish a task. The tasks performed by machine 10 may be associated with a particular industry such as paving, mining, construction, farming, transportation, or another industry known in the art. For example, machine 10 may embody a mobile machine such as the wheeled compactor depicted in FIG. 1, an on- or off-highway haul truck, or any other type of mobile machine known in the art. Machine 10 may include an operator station 12, from which operator control of machine 10 may be affected. Machine 10 may also include a drive system 14 supported by a frame of machine 10 and operatively connected to one or more driven and/or steerable traction devices 16, such as, for example, wheels, tracks, or belts located on each side of machine 10.

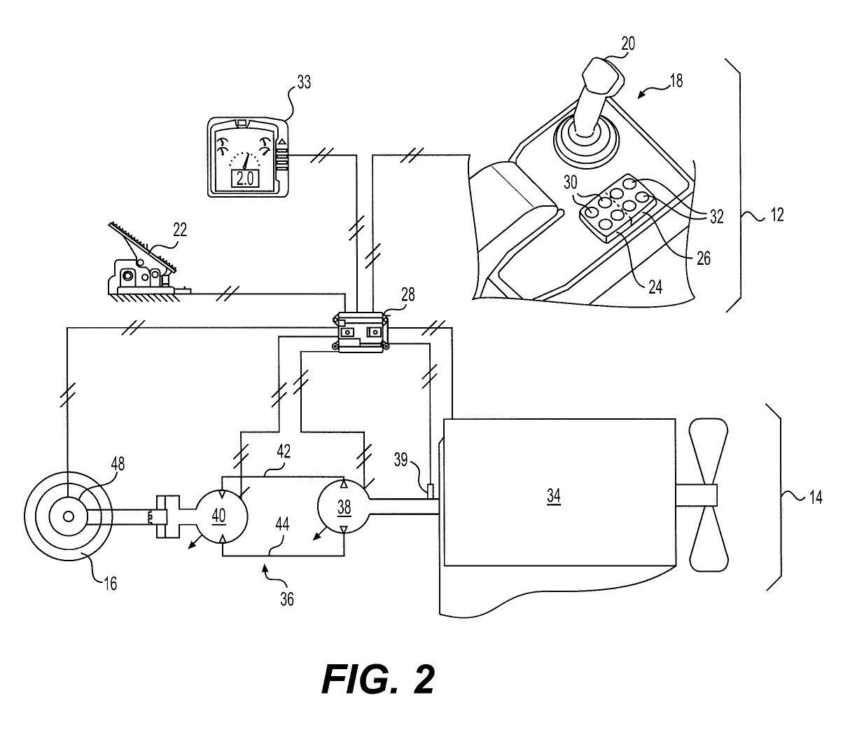

As illustrated in FIG. 2, operator station 12 may include an operator interface 18 proximate a seat (not shown) for generating machine command signals indicative of desired machine maneuvers and/or functions in response to operator input. In the disclosed embodiment, operator interface 18 may include a plurality of input devices including a throttle input 20, a brake input 22, a transmission input 24, and a speed input 26. It should be noted, however, that additional operator input devices may be included, if desired. Each input device may take the form of a joystick, a pedal, a push-button, a knob, a switch, or another known device. As an operator manipulates the input devices, the operator may expect and affect corresponding operations of machine 10.

Throttle input 20, in the disclosed exemplary embodiment, is shown as a joystick that is tiltable through a range from a neutral position to one or more maximum displaced positions to generate one or more corresponding displacement signals that are indicative of desired engine speeds during machine travel in particular directions. For example, throttle input 20 may be tiltable from the neutral position to a maximum displaced position in a first direction to generate a corresponding first displacement signal. Likewise, throttle input 20 may be tiltable from the neutral position to a maximum displaced position in a second direction to generate a second displacement signal. Values of the first and second displacement signals may correspond with desired amounts (e.g., percents) of a maximum allowable engine speed during machine travel in first and second directions (e.g., in forward and reverse traveling directions), respectively. For instance, when throttle input 20 is in the neutral position, the first signal may have a minimum value, for example about zero, indicating that an engine speed of machine 10 should be about 0% of a current maximum allowable engine speed. Similarly, when throttle input 20 is displaced to a point about halfway between the neutral position and the maximum displaced position in the first direction, the first signal may indicate a desired engine speed of about 50% of the maximum allowable engine speed. It is contemplated that a function other than percentage may be utilized, if desired, for example a linear or non-linear gain that is not a percent of the displacement position of throttle input 20. The first and second displacement signals generated by throttle input 20 may be directed to a controller 28 for further processing.

Brake input 22, in the disclosed embodiment, is shown as a foot pedal that is pivotable through a range from a neutral position to a maximum displaced position to generate one or more corresponding displacement signals indicative of a desire to decelerate machine 10. The displacement signals generated by brake input 22 may be directed to controller 28 for further processing.

Transmission input 24 and speed input 26, in the disclosed embodiment, may form an integral unit having multiple input components used by an operator to select different modes of operation. Specifically, transmission input 24 may be a touch pad having a plurality of push buttons 30 that, when pressed by the operator of machine 10, select one of any number of available transmission control settings (i.e., virtual gears or portions of a continuous range of transmission speed-to-torque ratios). For example, the operator may press a first of buttons 30 to select a first gear, in which drive system 14 may operate within a highest torque output range and a corresponding lowest travel speed range. Likewise, the operator may press a second of buttons 30 to select a second or higher gear, in which drive system 14 may operate with a lower torque output range and a corresponding higher travel speed range.

Speed input 26 may also be a touch pad having a plurality of push buttons 32 that, when pressed by the operator of machine 10, select one of any number of available engine speed limits corresponding to the maximum displaced position of throttle input 20. For example, the operator may press a first of push buttons 32 to select a first engine speed limit that allows a maximum engine speed of about 1200 rpm when throttle input 20 is tilted to the maximum displaced position in either the first or second directions. Likewise, the operator may press a second of push buttons 32 to select a second engine speed limit that allows a maximum engine speed of about 1500 rpm. It is to be appreciated that the maximum engine speed for each selection may be set to any desired value and/or that a particular push button 32 may correspond with two different maximum engine speeds, if desired, for example a forward traveling engine speed and a reverse traveling engine speed. It is also contemplated that transmission input 24 and speed input 26 may be completely separate components, if desired.

Operator station 12 may also be equipped with a monitor 33 used to display parameters indicating certain aspects of machine status and/or performance for operator acknowledgment. Monitor 33 may be one of a liquid crystal display, a cathode ray tube display, a plasma display, or any other type of display known in the art. Monitor 33 may be caused by controller 28 to display machine settings affected by input devices 20, 22, 24, and/or 26, for example a current speed setting (as provided by throttle input 20), a current transmission gear (as provided by transmission input 24), a current speed limit (as provided by speed input 26), and other parameters known in the art. It is to be appreciated that monitor 33 may itself also receive operator input by way of a touch-screen, software keys, and the like.

Controller 28 may be in communication with operator interface 18 and drive system 14 and configured to control operations of drive system 14 in response to signals received from the operator via interface 18. Communications between controller 28 and the other components of machine 10 may be facilitated by communication links and other suitable network architecture. The communication links may include wired and/or wireless non-proprietary links and protocols, or proprietary links and protocols based on known industry standards, such as J1939, RS-232, RP1210, RS-422, RS-485, MODBUS, CAN, SAEJ1587, Bluetooth, the Internet, an intranet, 802.11b or g, or any other communication links and/or protocols known in the art. The network architecture may include, alone or in any desired combination, a telephone-based network (such as a PBX or POTS), a satellite-based network, a local area network (LAN), a wide area network (WAN), a dedicated intranet, the Internet, and/or any other suitable network architecture.

Controller 28 may include computer-readable memory, such as read-only memories (ROM), random-access memories (RAM), and/or flash memory; secondary storage device(s), such as a tape-drive and/or magnetic disk drive; a microprocessor(s) (CPU), and/or any other components for running the disclosed application. The microprocessor(s) may comprise any suitable combination of commercially-available or specially-constructed microprocessors for controlling system operations in response to operator input. As such, controller 28 may include machine instructions and/or data stored as hardware, software, and/or firmware within the memory, secondary storage device(s), and/or microprocessors. Various other circuits may be associated with controller 28, such as power supply circuitry, signal conditioning circuitry, solenoid driver circuitry, and other types of circuitry, if desired.

As illustrated in FIG. 2, drive system 14 may include components that cooperate to generate and transmit power to traction devices 16 in response to commands from controller 28. In particular, drive system 14 may include a power source 34 configured to generate a power output, and at least one transmission unit 36 operatively coupled thereto to receive, convert, and/or transmit the power output in a useful manner to traction devices 16.

Power source 34 may comprise an internal combustion engine having multiple subsystems that cooperate to produce mechanical or electrical power output. For the purposes of this disclosure, power source 34 is depicted and described as a four-stroke diesel engine. It is to be appreciated, however, that power source 34 may be any other type of internal combustion engine such as, for example, a gasoline or a gaseous fuel-powered engine. The subsystems included within power source 34 may include, for example, a fuel system, an air induction system, an exhaust system, a lubrication system, a cooling system, or any other appropriate system. Controller 28 may be in communication with and able to regulate the operation of any one or more of the subsystems of power source 34.

A sensor 39 may be associated with power source 34 to sense an output speed thereof. Sensor 39 may embody, for example, a magnetic pickup-type sensor in communication with a magnet embedded within a rotational component of power source 34, such as a crankshaft, flywheel, or the like. During operation of power source 34, sensor 39 may detect a rotating magnetic field produced by the embedded magnet and generate a corresponding feedback signal in response. As such, in one aspect, the signal may have a frequency component directly proportional to the output speed of power source 34. Signals produced by sensor 39 that are indicative of an actual engine speed of power source 34 may be directed to controller 28 for further processing.

Transmission unit 36 may embody a hydrostatic transmission (hystat) having an infinite number of available torque-to-speed output ratios (i.e., virtual gears) within its continuous overall range. Transmission unit 36 may include a pump 38 coupled to receive the output of power source 34. Pump 38 may be operatively hydraulically connected to power a motor 40 via first and second passages 42, 44, and motor 40 may be driven by pressurized fluid from pump 38 to rotate traction devices 16 and propel machine 10. As will be described in more detail below, one or more operational characteristics of pump 38 and/or motor 40 may be responsively regulated by controller 28 to affect a desired torque-to-speed ratio or subset of ratios within the continuous range of transmission unit 36.

Pump 38 may have variable displacement and be controlled by controller 28 to draw fluid from motor 40 and discharge the fluid at a specified elevated pressure and/or rate back to motor 40 in two different directions. That is, pump 38 may include a stroke-adjusting mechanism, for example a swashplate, a position of which is hydro- or electro-mechanically adjusted based on, among other things, a desired speed and/or torque of motor 40 to thereby vary an output (e.g., a discharge pressure or rate) of pump 38. The displacement of pump 38 may be adjusted from a zero displacement position at which substantially no fluid is discharged from pump 38, to a maximum displacement position in a first direction at which fluid is discharged from pump at a maximum rate into first passage 42. Likewise, the displacement of pump 38 may be adjusted from the zero displacement position to a maximum displacement position in a second direction at which fluid is discharged from pump 38 at a maximum rate into second passage 44 (i.e., pump 38 may be an over-center pump). Pump 38 may be drivably connected to power source 34 of machine 10 by, for example, a countershaft, a belt, or in another suitable manner. Alternatively, pump 38 may be indirectly connected to power source 34 via a torque converter, a gear box, an electrical circuit, or in any other manner known in the art.

Motor 40 may be driven to rotate by a fluid pressure differential generated by pump 38. Specifically, motor 40 may include first and second chambers (not shown) located to either side of a pumping mechanism such as an impeller, plunger, or series of pistons (not shown). When the first chamber is filled with pressurized fluid from pump 38 via first passage 42 and the second chamber is drained of fluid returning to pump 38 via second passage 44, the pumping mechanism may be urged to move or rotate in a first direction (e.g., in a forward traveling direction). Conversely, when the first chamber is drained of fluid and the second chamber is filled with pressurized fluid, the pumping mechanism may be urged to move or rotate in an opposite direction (e.g., in a rearward traveling direction). The flow rate of fluid into and out of the first and second chambers may determine an output velocity of motor 40, while a pressure differential across the pumping mechanism may determine an output torque. It is contemplated that a displacement of motor 40 may be variable, if desired, such that for a given flow rate and/or pressure of supplied fluid, a speed and/or torque output of motor 40 may be adjusted by controller 28.

In some embodiments, motor 40 may also be mechanically driven to create a pressure differential within transmission unit 36 that functions to slow machine 10 and/or recuperate energy during deceleration of machine 10. In particular, there may be times when traction devices 16 rotate at a faster speed and/or with greater torque than motor 40 would otherwise be driven by fluid from pump 38. In this situation, motor 40 may function as a pump, pressurizing fluid directed back to pump 38, which may function as a motor in this situation. When motor 40 pressurizes fluid, energy imparted to motor 40 by traction devices 16 may be dissipated, thereby slowing the rotation of traction devices 16. The pressurized fluid directed from motor 40 back to pump 38 may reduce a load placed on power source 34 by pump 38 and, in some situations, even be used to drive power source 34.

In some applications, the use of motor 40 to slow and/or stop machine 10 may be insufficient. In these applications, machine 10 may be equipped with a braking device 48. Braking device 48 may be operatively associated with one or more traction devices 16 of machine 10 and be configured to retard the motion of machine 10 when commanded to do so by controller 28 (e.g., in response to a braking signal received via brake input 22). In one embodiment, braking device 48 may include a hydraulic pressure-actuated wheel brake such as, for example, a disk brake or a drum brake that is disposed intermediate a wheel of traction device 16 and a corresponding final drive assembly (not shown) of machine 10. When actuated, pressurized fluid within braking device 48 may be utilized to increase the rolling friction of machine 10.

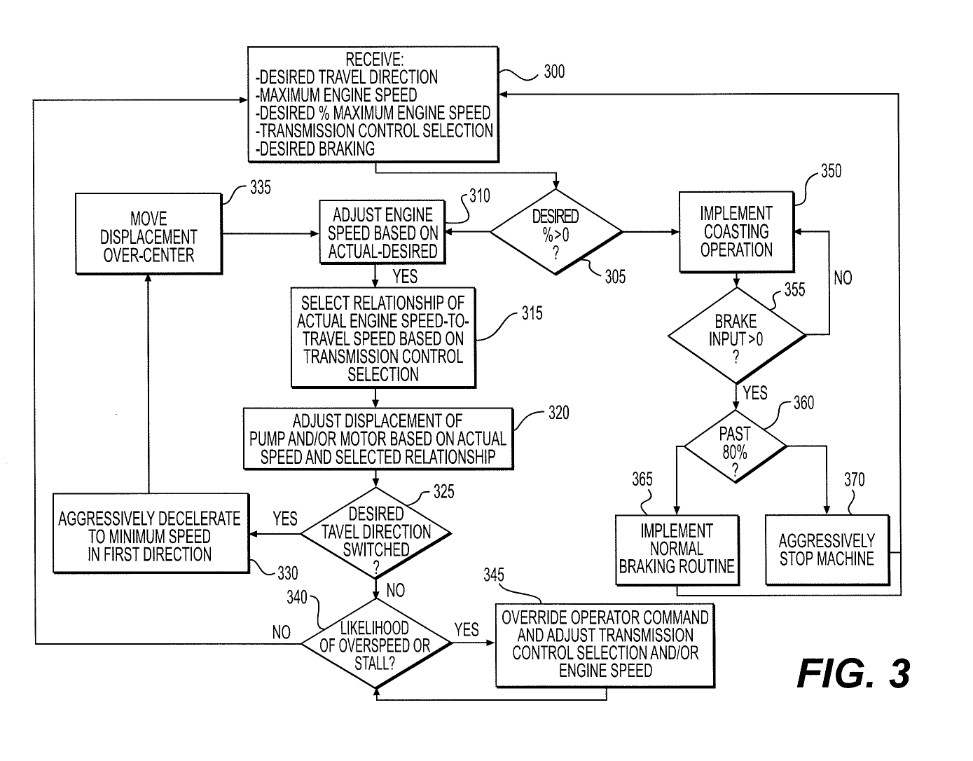

FIG. 3 illustrates an exemplary method of controlling drive system 14 in response to signals received from operator station 12. FIG. 3 will be discussed in detail in the following section to further illustrate the disclosed concepts.

### INDUSTRIAL APPLICABILITY

The disclosed drive system may be applicable to any mobile machine having a hystat. The disclosed drive system may allow operator selection of discrete speed ranges corresponding to familiar speed ranges of power-shift transmissions, which may allow experienced operators to feel more comfortable operating the machine. Additionally, the selectable engine speeds may allow the operator to fully displace throttle input 20 without exceeding a desired maximum speed, saving the operator undue fatigue from holding throttle input 20 at an intermediate position in rough terrain. Accordingly, the known efficiency benefits of a hystat may be realized in any mobile machine, without sacrificing operator comfort and familiarity associated with the earlier transmission types. Operation of drive system 14 will now be described.

As shown in FIG. 3, during startup of drive system 14, controller 28 may receive input from the operator of machine 10 (Step 300). The input may include, among other things, a desired travel direction, a maximum allowable engine speed, a desired engine speed, a transmission control selection, and any desired braking. The desired travel direction may be indicated by the operator via the tilt direction of throttle input 20. The maximum engine speed may be selected via speed input 26 and correspond with a maximum engine speed that the operator would like power source 34 to achieve when throttle input 20 is tilted to its maximum displaced position. The desired engine speed may be selected via throttle input 20 as a function (e.g., a percent) of the maximum engine speed. The transmission control selection may be indicated by the operator via transmission input 24 and correspond with a specific portion of the overall speed-to-torque range of transmission unit 36. Desired braking may be indicated via manipulation of braking input 22.

After receiving signals from each of throttle input 20, braking input 22, transmission input 24, and speed input 26, controller 28 may determine if acceleration of machine 10 is desired (Step 305). Controller 28 may determine that acceleration of machine 10 is desired when the desired engine speed is greater than a threshold amount (e.g., greater than about 0%) of the maximum allowable engine speed and a non-zero transmission control setting has been selected (i.e., when neutral or park settings of transmission unit 36 have not been selected).

When controller 28 determines that acceleration of machine 10 is desired by the operator of machine 10, controller 28 may adjust a speed of power source 34 based on a difference between the desired engine speed received via throttle input 20 and an actual engine speed of power source 34 that is sensed by sensor 39 (Step 310). The speed of power source 34 may be adjusted by issuing appropriate commands to power source 34 (e.g., by issuing commands to the fuel and/or air induction systems) until the difference between the desired engine speed and the actual engine speed is less than an acceptable amount. Controller 28 may then select for use a particular relationship from among a plurality of available relationships contained within an acceleration map stored in the memory of controller 28 (Step 315). In the disclosed embodiment, each relationship may correspond with the transmission control selection received from the operator, and take the form of an acceleration curve that relates the actual engine speed to a travel speed of machine 10. Controller 28 may use the selected relationship to adjust displacement(s) of pump 38 and/or motor 40 until the travel speed corresponding with the actual engine speed is substantially achieved (Step 320). It should be noted that, although steps 310-320 are shown and described as occurring in a particular order, it is contemplated that these steps may be completed in a different order or completed simultaneously, if desired.

If during travel of machine 10 in a particular direction (e.g., in a forward direction), the operator quickly tilts throttle input 20 through the neutral position to another displaced position in an opposite direction (e.g., in less than a minimum length of time), the operator may be indicating a desire for machine 10 to switch travel directions (e.g., from forward to reverse) as quickly as possible. In some instances, the operator may switch the displacement directions of throttle input 20 without first waiting for machine 10 to come to a complete stop in the first direction. If controller 28 were to cause machine 10 to accelerate exactly as requested by the operator, machine 10 could be caused to operate in a jerky manner (e.g., to spin out) that, in the example of the compacting paving operation, could mar the work surface. Accordingly, controller 28 may be configured to detect when the operator has quickly switched displacement directions of throttle input 20 (Step 325) and respond accordingly.

When controller 28 determines that the operator of machine 10 has quickly switched displacement directions of throttle input 20, controller 28 may aggressively decelerate machine 10 to below a minimum speed (e.g., to about a complete stop) in the original direction (Step 330), and then flip the stroke-adjusting mechanism of pump 38 over center (Step 335), before accelerating machine 10 in the new direction following the normal acceleration routine (i.e., before returning to steps 310-320). In some embodiments, this aggressive deceleration of machine 10 may involve immediate displacement control of only pump 38. In other embodiments, however, the aggressive deceleration of machine 10 may involve only activation of braking device 48 or simultaneous control of pump displacement and brake activation. In yet other embodiments, the aggressiveness of this deceleration may be based, at least partially, on an initial speed in the original direction. That is, for higher initial speeds, controller 28 may implement a more aggressive deceleration than implemented for lower initial speeds.

At any time during operation of machine 10, it may be possible for machine 10 to overspeed or stall when controlled according to the operator selected engine speed and transmission control selection. For example, when traveling down a steep incline in a selected low gear, it may be possible for motor 40 to drive power source 34 through pump 38 to an excessive speed that could result in damage to power source 34. In another example, when traveling up a steep incline in a selected high gear, it may be possible for the load on power source 34 to cause power source 34 to lug to a low speed sufficient to cause instabilities in the operation of power source 34. Accordingly, controller 28 may continuously monitor the speed of power source 34 via sensor 39 and determine if overspeeding or stalling is likely or has already occurred (Step 340).

If there is a likelihood of power source 34 overspeeding or stalling, controller 28 may override selections made by the operator (e.g., override the transmission control selection, the desired engine speed, and/or the maximum allowable engine speed), and adjust operation of machine 10 to protect the components of machine 10 (Step 345). For example, when overspeed is likely or already occurring, controller 28 may cause transmission unit 36 to adjust to a higher gear such that the speed of power source 34 may be reduced. In another example, when stall is likely or already occurring, controller 28 may cause transmission unit 36 to adjust to a lower gear such that the speed of power source 34 may increase. It should be noted that, during completion of step 325, when controller 28 determines that throttle input 20 has not switched directions, control may skip step 330-335 and continue through steps 340-345 in the manner described above.

Returning to step 305, when controller 28 determines that acceleration of machine 10 is no longer desired by the operator of machine 10 (e.g., when throttle input 20 has been returned to the neutral position), controller 28 may responsively implement a coasting operation (Step 350). In particular, controller 28 may begin adjusting the speed-to-torque ratio of transmission unit 36 in a gradual manner such that machine 10 slows down by a desired amount over a desired period of time. As described above, the speed-to-torque ratio of transmission unit 36 may be adjusted by adjusting the displacements of pump 38 and/or motor 40. In the disclosed exemplary embodiment, controller 28 simultaneously adjusts the displacements of both pump 38 and motor 40 during the coasting operation. It is contemplated that controller 28 may also adjust operation of power source 34 (e.g., of the fuel and/or air induction subsystems of power source 34) such that the actual speed of power source 34 remains at about the desired engine speed selected by the operator during implementation of the transmission adjustments.

The deceleration of machine 10 during the coasting operation may be substantially linear for a majority of the period of time that machine 10 decelerates (e.g., for about 70-90% of the period of time), and then include a short curvilinear deceleration toward the very end of the time period (e.g., for about the remaining 10-30% of the period of time). This curvilinear deceleration may help to feather machine 10 to a complete stop, which may be helpful in applications such as compacting pavement where an immediate stop could mar the newly-compacted pavement. The length of the time period during which machine 10 decelerates during the coasting operation may be variable and at least partially dependent on a travel speed of machine 10 and/or the actual engine speed of power source 34 at the time that the coasting operation is initiated. In the disclosed embodiment, controller 28 may use a coasting deceleration map having at least one deceleration curve that relates the travel speed of machine 10 to a time period elapsed since initiation of the coasting operation. It is contemplated, however, that other methods and/or algorithms may be utilized to deceleration machine 10 during coasting, if desired.

During operation of machine 10, there may be times after release of throttle input 20 when the operator of machine 10 desires to slow machine 10 faster than implemented via the coasting operation described above. In these situations, the operator may move brake input 22 a distance toward the maximum displaced position. Controller 28 may detect this movement (Step 355) and selectively interrupt the coasting operation to implement one of at least two different braking operations depending on the displaced position of brake input 22. In particular, if, during a comparison step 360, controller 28 determines that brake input 22 has been displaced less than about 70-90% of the distance from its neutral position to its maximum displaced position (e.g., past about 80%), controller 28 may implement a normal braking routine (Step 365). If during completion of step 360, however, controller 28 determines that brake input 22 has been displaced to a position more than about the 70-90% position, controller 28 may instead aggressively stop machine 10 (Step 370). To aggressively stop machine 10, controller 28 may activate braking device 48, for example to a degree substantially proportional to the displaced position of brake input 22. In some embodiments, controller 28 may only activate braking device 48 when a particular transmission gear has been selected by the operator, for example only when transmission unit 36 is operating in second gear or third gear. It is contemplated that, in the same or other embodiments, activation of braking device 48 may continue until machine 10 has come to a complete stop, even if the operator releases brake input 22 before the complete stop has been achieved.

In one embodiment, the normal braking routine may first involve displacement control of only pump 38, but in a manner more aggressive than associated with the coasting operation described above. That is, controller 28 may utilize a braking deceleration map stored in memory that, like the coasting deceleration map, includes at least one deceleration curve relating a travel speed of machine 10 to a time elapsed since initiation of the operation. The time period of deceleration included in the braking deceleration map, however, may be shorter than the time period included in the coasting deceleration map. After controller 28 has adjusted the displacement of pump 38 to its fullest extent, controller 28 may then make adjustments to motor 40 to continue deceleration during the normal braking routine, if desired.

It will be apparent to those skilled in the art that various modifications and variations can be made to the disclosed drive system. Other embodiments will be apparent to those skilled in the art from consideration of the specification and practice of the disclosed drive system. It is intended that the specification and examples be considered as exemplary only, with a true scope being indicated by the following claims and their equivalents.

What is claimed is:

1. A drive system for a mobile machine, comprising:
an engine;
a pump driven by the engine to pressurize fluid;
a motor hydraulically connected to the pump via an inlet passage and an outlet passage;
a speed input movable by an operator to select a maximum allowable speed of the engine;
a throttle input movable by the operator to indicate a desired speed of the engine as a function of the maximum allowable speed of the engine;
a transmission input movable by the operator to select a desired transmission control setting from a plurality of available transmission control settings; and
a controller in communication with the engine, the pump, the motor, the throttle input, the speed input, and the transmission input, the controller being configured to:
selectively adjust operation of the engine based on the throttle input to reduce a difference between an actual engine speed and the desired speed of the engine;
select for use a particular relationship between the actual engine speed and a travel speed of the mobile machine from a plurality of available relationships based on the desired transmission control setting selected by the operator; and
selectively adjust displacements of the pump and the motor based on the actual engine speed and the selected particular relationship.

2. The drive system of claim 1, wherein the plurality of available relationships are represented by different acceleration curves contained within a control map stored in a memory of the controller.

3. The drive system of claim 2, wherein the displacements of the pump and the motor are changed during travel speed control of the mobile machine using a given one of the different acceleration curves.

4. The drive system of claim 1, wherein the throttle input is also movable by the operator to indicate a desired travel direction.

5. The drive system of claim 4, wherein the throttle input is a joystick pivotable from a neutral position toward a maximum displaced position in a first direction to indicate the desired speed of the engine during travel in a forward direction, and from the neutral position toward a maximum displaced position in a second direction to indicate the desired speed of the engine during travel in a reverse direction.

6. The drive system of claim 5, wherein the controller is further configured to:
determine when the joystick has been moved from a displaced position in the first direction to a displaced position in the second direction in less than a threshold period of time;
responsively decelerate the mobile machine faster than otherwise implemented when the joystick is returned to the neutral position; and
responsively accelerate the mobile machine after a travel speed of the mobile machine in the first direction falls below a threshold speed.

7. The drive system of claim 1, wherein the speed input is a keypad having a plurality of push buttons corresponding to different available engine speed settings.

8. The drive system of claim 1, wherein the transmission input is keypad having a plurality of push buttons corresponding to different available transmission control settings.

9. The drive system of claim 1, further including a brake input movable by the operator to indicate a desire to decelerate the mobile machine.

10. The drive system of claim 9, wherein the controller is in further communication with the brake input and configured to selectively override at least one of the desired speed of the engine and the particular relationship between the actual engine speed and the travel speed of the mobile machine based on the desire to decelerate the mobile machine.

11. The drive system of claim 10, wherein:
the brake input is movable from a neutral position through a range to a maximum displaced position; and
the controller is configured to:
selectively reduce the desired speed of the engine when the brake input is moved from the neutral position to a displaced position that is less than about 70-90% of its range; and
selectively override the particular relationship between the actual engine speed and the travel speed when the brake input is moved from the neutral position to a displace position that is greater than about 70-90% of its range.

12. The drive system of claim 1, wherein the controller is further configured to:
determine a likelihood of the engine overspeeding or stalling; and
selectively override at least one of the desired speed of the engine and the particular relationship between the actual engine speed and the travel speed of the mobile machine based on the likelihood of the engine overspeeding or stalling.

13. A method of driving a mobile machine, comprising:
pressurizing fluid with an engine-powered pump;
directing pressurized fluid from the pump through a motor to propel the mobile machine;
receiving a second operator input indicative of a maximum allowable engine speed;
receiving a first operator input indicative of a desired engine speed as a function of the maximum allowable engine speed;
receiving an operator selection of a desired transmission control setting from a plurality of available transmission control settings;
selectively adjusting operation of an engine based on a difference between the desired engine speed and an actual engine speed;
selecting for use a particular relationship between the actual engine speed and a travel speed of the mobile machine from a plurality of available relationships based on the desired transmission control setting selected by an operator of the mobile machine; and
selectively adjusting displacements of the pump and motor based on the actual engine speed and the selected particular relationship.

14. The method of claim 13, wherein the plurality of available relationships are represented by different acceleration curves contained within a control map.

15. The method of claim 14, wherein the displacements of the pump and the motor are changed during travel of the mobile machine using a given one of the different acceleration curves.

16. The method of claim 13, wherein:
the first operator input also indicates a desired travel direction of the mobile machine; and
the method further includes:
determining when the first operator input indicates a desire to change travel directions in less than a threshold period of time;
responsively decelerating the mobile machine faster than otherwise implemented when the first operator input indicates a desired minimum engine speed; and
responsively accelerating the mobile machine after a travel speed of the mobile machine in a current traveling direction falls below a threshold speed.

17. The method of claim 13, further including:
receiving a third operator input indicative of a desire to decelerate the mobile machine; and
selectively overriding at least one of the desired engine speed and the particular relationship between the actual engine speed and the travel speed of the mobile machine based on the desire to decelerate the mobile machine.

18. The method of claim 17, wherein selectively overriding at least one of the desired engine speed and the particular relationship between the actual engine speed and the travel speed of the mobile machine includes:
selectively overriding the desired engine speed when the third operator input indicates a desire to gradually decelerate the mobile machine; and
selectively overriding the particular relationship between the actual engine speed and the travel speed of the mobile machine when the third operator input indicates a desire to immediately decelerate the mobile machine.

19. The method of claim 13, further including:
determining a likelihood of engine overspeed or engine stall; and
selectively overriding at least one of the desired engine speed and the particular relationship between the actual engine speed and the travel speed of the mobile machine based on the likelihood of engine overspeed or engine stall.

20. A mobile machine, comprising:
a frame;
a plurality of traction devices operatively coupled to the frame;
an engine supported by the frame;
a pump powered by the engine to pressurize fluid;
a motor driven by the pump to propel at least one of the plurality of traction devices;
an operator station having at least:
a speed input movable by an operator to select a maximum allowable speed of the engine;
a throttle input movable by the operator to indicate a desired speed of the engine as a function of the maximum allowable speed, and a desired travel direction of the mobile machine;
a transmission input movable by the operator to select a desired transmission control setting from a plurality of available transmission control settings; and
a brake input movable by the operator to indicate a desire to decelerate the mobile machine; and
a controller in communication with the engine, the pump, the motor, the throttle input, the speed input, the transmission input, and the brake input, the controller being configured to:
selectively adjust operation of the engine based on the throttle input and the speed input to reduce a difference between an actual engine speed and the desired speed of the engine;
select for use a particular acceleration curve relating the actual engine speed and a travel speed of the mobile machine from a plurality of available curves stored in a memory of the controller based on the desired transmission control setting selected by the operator;
selectively adjust displacements of the pump and the motor based on the actual engine speed and the particular acceleration curve;
selectively override at least one of the desired speed of the engine and the particular acceleration curve based on the desire to decelerate the mobile machine;
determine a likelihood of the engine overspeeding or stalling; and
selectively override at least one of the desired speed of the engine and the particular acceleration curve based on the likelihood of the engine overspeeding or stalling.
